(19) United States
(12) Patent Application Publication
(10) Pub. No.: US 2024/0022104 A1
(43) Pub. Date: Jan. 18, 2024

(54) SERIES FORMATION SYSTEMS AND METHODS

(71) Applicant: ZHUHAI TITANS NEW POWER ELECTRONICS CO., LTD., Zhuhai (CN)

(72) Inventors: Feng MIAO, Zhuhai (CN); Liguo QIU, Zhuhai (CN)

(21) Appl. No.: 18/374,086

(22) Filed: Sep. 28, 2023

Related U.S. Application Data
(63) Continuation-in-part of application No. 17/775,300, filed on May 8, 2022, now Pat. No. 11,811,016.

(30) Foreign Application Priority Data
Jul. 13, 2020 (CN) 202010669723.6

(51) Int. Cl. H02J 7/00

(52) U.S. Cl. CPC H02J 7/007182; H02J 7/00304

(57) ABSTRACT

A series formation system includes a power module and at least two formation modules electrically connected to the power module in series. The at least two formation modules are connected in series. The power module is configured to supply power to the formation modules. Each of the formation modules includes a battery cell and a formation control circuit connected between the power module and the battery cell. The formation control circuit is configured to control the each of the formation modules to work in one of: a constant current charging mode in which a current flowing through the battery cell is substantially constant, and a constant voltage charging mode in which a voltage across the battery cell is substantially constant.

### CROSS-REFERENCE TO RELATED APPLICATIONS

This application is a continuation-in-part of U.S. patent application Ser. No. 17/775,300, filed on May 8, 2022, which is a national phase application based upon an International Application No. PCT/CN2020/112947, filed on Sep. 2, 2020, which claims priority to Chinese Patent Application No. 202010669723.6, filed on Jul. 13, 2020. The disclosures of the aforementioned applications are incorporated herein by reference in their entireties.

### TECHNICAL FIELD

The present disclosure relates to secondary battery manufacturing technologies, and more particularly, to series formation systems and methods.

### BACKGROUND

When performing battery formation on batteries, multiple batteries can be connected in series. By forming the multiple batteries connected in series at the same time, a number of wires and energy loss caused by the wires can be effectively reduced. When a battery is charged to reach a specified voltage value with a constant current, it needs to switch to a constant voltage charging mode.

However, due to differences between the multiple batteries connected in series, the times when the multiple batteries respectively reach the specified voltage value are different. Generally, for series formation devices, multiple batteries connected in series are firstly placed in a constant current charging device for constant current charging. When some of the multiple batteries connected in series reach the specified voltage value, the some batteries are transferred to a constant voltage charging device for constant voltage charging. The above-mentioned formation method requires a plurality of devices to complete a battery formation process, has a low formation efficiency, and affects battery quality after the formation.

### SUMMARY

One or more embodiments of the present disclosure provide a series formation system. The series formation system includes a power module and at least two formation modules connected in series with the power module, wherein the at least two formation modules are connected in series. The power module is configured to supply power to the at least two formation modules. Each of the formation modules includes a battery cell and a formation control circuit connected between the power module and the battery cell, the formation control circuit being configured to control the each of the formation modules to work in one of: a constant current charging mode in which a current flowing through the battery cell is substantially constant, and a constant voltage charging mode in which a voltage across the battery cell is substantially constant. The each of the formation modules is controlled to: work in the constant current charging mode for a first period of time to perform constant current charging of the battery cell; and in response to determining that the voltage across the battery cell reaches a preset voltage value, the each of the formation modules is configured to work in the constant voltage charging mode to perform constant voltage charging of the battery cell.

One or more embodiments of the present disclosure provide a series formation method applied to a series formation system. The series formation system includes: a power module and at least two formation modules connected in series with the power module, the at least two formation modules are connected in series, and each of the formation modules comprise a battery cell and a formation control circuit. The method includes: transmitting electrical energy from the power module to each of the formation modules for battery formation of the battery cell; the formation control circuit controlling the each of the formation modules to work in a constant current charging mode for a first period of time to perform constant current charging of the battery cell; in response to determining that the voltage across the battery cell reaches a preset voltage value, the formation control circuit switching the each of the formation modules to a constant voltage charging mode to perform constant voltage charging of the battery cell; and in response to determining that the constant voltage charging is completed, disconnecting the battery cell with the series formation system.

### BRIEF DESCRIPTION OF THE DRAWINGS

FIG. 1 is a schematic diagram of a series formation system according to some embodiments of the present disclosure.

FIG. 2 is a schematic diagram of a series formation system including a current limiting module according to some embodiments of the present disclosure.

FIG. 3 is a schematic diagram of a series formation system including a first filter module according to some embodiments of the present disclosure.

FIG. 4 is a schematic diagram of a series formation system including a second filter module according to some embodiments of the present disclosure.

FIG. 5 is a schematic diagram of another series formation system according to some embodiments of the present disclosure.

FIG. 6 is a schematic diagram of still another series formation system according to some embodiments of the present disclosure.

FIG. 7 is a schematic flowchart of a series formation method according to some embodiments of the present disclosure.

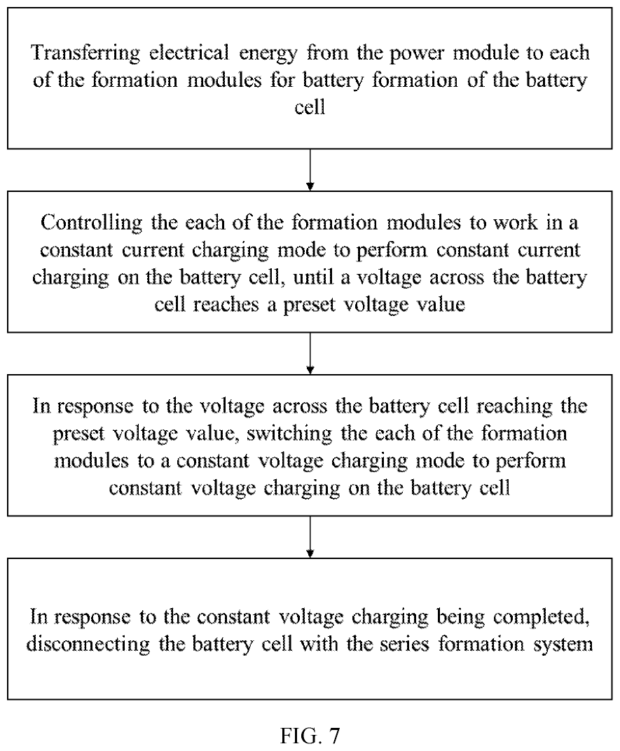

### DETAILED DESCRIPTION

To make the purpose, technical solutions, and advantages of the present disclosure clearer, the present disclosure will be further described in detail below in conjunction with the accompanying figures and embodiments. It should be understood that the specific embodiments described here are only used to explain the application and are not used to limit this application.

In addition, the terms “first” and “second” are only used for descriptive purposes, and cannot be understood as indicating or implying the relative importance or implicitly indicating the number of the indicated technical features. Therefore, the features defined with “first” and “second” may explicitly or implicitly include at least one feature. In the description of the invention, “multiple” means at least two, such as two, three, etc., unless otherwise clearly specified limitation is provided.

In a secondary battery production and manufacturing process, a battery needs to undergo a battery formation process after being manufactured, so that an active material in the battery is converted into a material with a normal electrochemical effect by means of first charging, and an effective passivation film or a solid electrolyte interface film is formed at an electrode (mainly a negative terminal). To form a uniform solid electrolyte interface film on a surface of a negative terminal material, it is usually necessary to firstly put the battery into a constant current charging device for constant current charging. When a voltage value of the battery reaches a preset voltage value, the battery is transferred to a constant voltage charging device for constant voltage charging to complete the battery formation. In this formation method, the battery is transferred between the constant current charging device and the constant voltage charging device, which requires a plurality of devices to work together and has high cost of the devices. Moreover, the transfer of the battery takes a long time, and it also easily causes damage to the battery, which seriously affects quality and production efficiency of the battery.

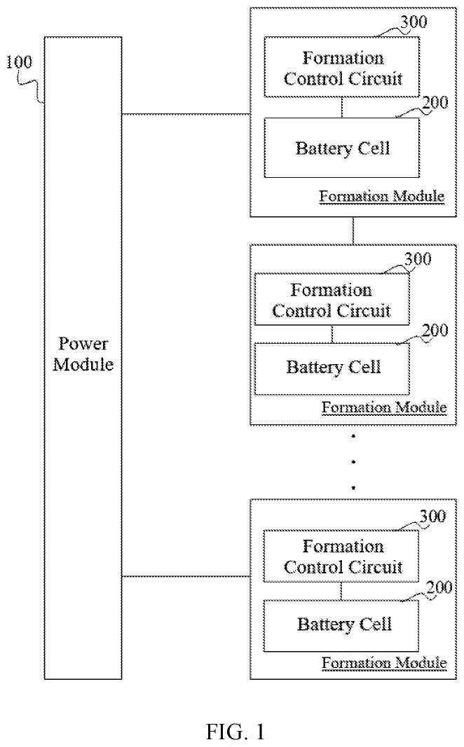

To this end, please refer to FIG. 1. In some embodiments of the present disclosure, a series formation system is provided. The series formation system includes: a power module 100 and at least two formation modules.

The power module 100 is connected with the at least two formation modules in series, and the formation modules is connected in series. The power module 100 is used to supply power to each of the formation modules. In some embodiments, the power module 100 is a constant current source, and current flows from a current output terminal of the power module 100, passes through the formation modules connected in series in turn, and reaches a current input terminal of the power module 100.

Because the power module 100 is the constant current source, and each of the formation modules is connected with the power module 100 in series, a current flowing into each formation module is equal and a magnitude thereof remains the same. In addition, the magnitude of the constant current output by the power module 100 may be adjusted according to actual requirements of production and formation, which is not limited in this disclosure. Moreover, the at least two formation modules are provided to realize formation of multiple batteries at the same time to improve production efficiency.

In some embodiments of the present disclosure, each formation module includes: a formation control circuit 300 and a battery cell 200. The formation control circuit 300 is electrically connected between the power module 100 and the battery cell 200. The formation control circuit 300 is configured to control a voltage across the battery cell 200 and/or to control a current flowing through the battery cell 200, so that the battery cell 200 can be switched between a constant current charging mode and a constant voltage charging mode.

Further, each formation module is configured with the constant current charging mode and the constant voltage charging mode, so that the battery cell 200 of the each formation module may be charged in the constant current charging mode or the constant voltage charging mode. A current and/or a voltage output by the power module 100 may be adjusted by the formation control circuit 300 and then input to the battery cell 200. In some embodiments, each formation module is controlled to: work in the constant current charging mode for a first period of time to perform constant current charging of the battery cell 200; and in response to determining that the voltage across the battery cell 200 reaches a preset voltage value, work in the constant voltage charging mode to perform constant voltage charging of the battery cell 200. In some embodiments, the first period of time may be a time period from a start time point when the each formation module is switched to the constant current charging mode to an end time point when the voltage across the battery cell 200 reaches the preset voltage value. The first period of time may be any suitable time period, which is not limited herein.

When battery cell 200 is in the constant current charging mode, the battery cell 200 is in a constant current charging state, a charging current flowing through battery cell 200 is substantially constant, and a charging voltage across the battery cell 200 changes. When the battery cell 200 is in the constant voltage charging mode, the battery cell 200 is in a constant voltage charging state, the charging voltage applied to the battery cell 200 is substantially constant, and the charging current flowing through the battery cell 200 changes. That the charging current is substantially constant means that the charging current fluctuates within a certain current range. That the charging voltage is substantially constant means that the charging voltage fluctuates within a certain voltage range. A specific voltage fluctuation range and a specific current fluctuation range may be set according to control accuracy of the voltage and current, which is not limited herein.

In some embodiments, when the power module 100 is a constant current source, a constant current output by the power module 100 is adjusted by the formation control circuit 300 and then flows into the battery cell 200. When the formation control circuit 300 controls the current flowing into the battery cell 200 to be substantially constant, the battery cell 200 is in the constant current charging state. When the formation control circuit 300 controls a change of the current flowing through the battery cell 200 to keep the voltage across the battery cell 200 substantially constant, the battery cell 200 is in the constant voltage charging state.

In a battery formation process, each formation module firstly works in the constant current charging mode, and the battery cell 200 of the each formation module undergoes a constant current charging for a period to reach a preset voltage value; and in response to the battery cell 200 reaching the preset voltage value, the battery cell 300 then undergoes a constant voltage charging, at this time, the each formation module is in the constant voltage charging mode. When starting the constant current charging mode or before starting the constant current charging mode, a voltage of each formation module is less than the preset voltage value. In this way, after performing the constant current charging of the at least two formation modules for a period of time, voltages of battery cells 200 in at least part of the formation modules are within a preset range (i.e., reaching the preset voltage value). The preset range of the voltages of the battery cells 200 may be set according to control accuracy requirements, which is not limited herein. For example, when the power module 100 is the constant current source, the voltage across the battery cell 200 is monitored in real time during the battery formation process. In some embodiments, the formation control circuit 300 controls the current flowing through the battery cell 200 with a voltage less than the present voltage value to be substantially constant, so that the batter cell 200 is in the constant current charging mode, and the voltage across the battery cell 200 increases continuously. Thus, when the voltage across the battery cell 200 is monitored to reach the preset voltage value, the current flowing through the battery cell 200 is adjusted to switch the battery cell 200 to the constant voltage charging mode. A magnitude of the preset voltage value may be set according to actual production requirements, which is not limited herein.

In some embodiments, because a voltage value of the battery cell 200 before the formation is very small, it will inevitably be lower than the above-mentioned preset voltage value. Therefore, during the battery formation process, an initial voltage value of the battery cell 200 in each formation module is lower than the preset voltage value. That is, during the battery formation process, the formation control circuit 300 in each formation module controls the current flowing through the battery cell 200 in the each formation module to be constant, so that the battery cell 200 is firstly in the constant current charging mode for charging. Because each formation module is connected with the power module 100 in series, the current passing through each battery cell 200 is equal and remains constant.

In an actual production process, due to differences between the battery cells 200, there are differences in the initial voltage values of the battery cells 200 and differences in voltage rising speeds of the battery cells 200 during the constant current charging. This makes times for the battery cells 200 to reach the preset voltage value inconsistent, that is, voltage values of some battery cells 200 among these battery cells 200 reach the preset voltage value earlier, and voltage values of remaining battery cells 200 are still lower than the preset voltage value when the some battery cells 200 reach the preset voltage value. In such case, the formation control circuit 300 directly switches the battery cells 200 with the voltage values within a preset range (i.e., reaching the present voltage value) from the constant current charging mode to the constant voltage charging mode. For example, when the power module 100 is a constant current source, the formation control circuit 300 adjusts the current flowing through the battery cell 200 with the voltage value higher than or equal to the preset voltage value, so that battery cell 200 is directly switched from the constant current charging mode to the constant voltage charging mode. The remaining battery cells 200, with the voltage values lower than the preset voltage value, are still charged in the constant current charging mode.

The above series formation system may simultaneously form multiple battery cells 200, which may perform the constant current charging on some battery cells 200 and perform the constant voltage charging on some other battery cells simultaneously, thereby improving an efficiency of the formation.

During the battery formation process, each battery cell 200 is firstly in the constant current charging mode, so that a voltage value of each battery cell 200 continues to rise. Subsequently, the each battery cell 200 with the voltage value within the preset range is directly switched from the constant current charging mode to the constant voltage charging mode. There is no need to transfer the battery cell 200 between a constant current charging device and a constant voltage charging device, and only one device is needed to perform the constant current charging and the constant voltage charging on the battery cell 200, which reduces cost of devices and occupation of space. Moreover, because the transfer between the constant current charging device and the constant voltage charging device is eliminated, time is saved and production efficiency is improved, meanwhile, scratches on surfaces of the battery cell 200 during the transfer process are avoided, thereby improving product quality.

In addition, through the above series formation system, during the battery formation process, there is no need to wait for all of the battery cells 200 to reach the preset voltage value before performing the constant voltage charging of the battery cells 200, which avoids waste of electric energy caused by overcharging, saves resources, and reduces cost. A seamless connection between the constant current charging mode and the constant voltage charging mode makes the solid electrolyte interface film generated during the battery formation of the battery cell 200 more dense and makes the electrochemical property of the battery cell 200 more stable. Compared with constant voltage charging at an interval after constant current charging, the product quality of the battery cell 200 is greatly improved.

When the battery cell 200 reaches the preset voltage value, if the battery cell 200 continues to be charged in the constant current charging mode instead of switching to the constant voltage charging mode for charging, the battery cell 200 may easily be excessively polarized, thereby affecting the product quality of the battery cell 200. Besides, since the times for the battery cells 200 to reach the preset voltage value are inconsistent, waiting all of the battery cells 200 to reach the preset voltage value before performing the constant voltage charging further cause durations of excessive constant current charging for each battery cell 200 to be inconsistent, which not only affects the product quality of the battery cell 200, but also makes the quality of the battery cells 200 formed in a same batch in the series formation system inconsistent, which is not conducive to consistency of products. Therefore, if each battery cell 200 in the series formation system can be switched to the constant voltage charging mode immediately after reaching the preset voltage value, not only is formation quality of each battery cell 200 ensured, but also consistency of multiple battery cells 200 is ensured, so that the formed battery cells 200 are all high-quality products with extremely similar electrochemical properties.

It should be noted that, compared to non-series formation devices, the series formation system provided in the present disclosure can not only improve consistency of the battery cells 200, but also reduce line loss.

In some embodiments, each formation module includes: a power input terminal and a power output terminal. When the at least two formation modules are connected in series, in a series connection direction, a power input terminal of each of the formation modules except the first one of the formation modules is electrically connected to a power output terminal of one of the formation modules immediately preceding the each formation module. In the series connection direction, a power input terminal of the first one of the formation modules is electrically connected to a positive terminal of the power module 100, and a power output terminal of the last one of the formation modules is electrically connected to a negative terminal of the power module 100. As shown in FIG. 1, when the power module 100 is a constant current source, the current flows from the positive terminal of the power module 100, flows into the first formation module through the power input terminal of the first formation module in the series connection direction, then flows out from a power output terminal of the first formation module, then flows into a second formation module through a power input terminal of the second formation module, then flows out from a power output terminal of the second formation module, and so on, until passing through a power input terminal of the last formation module in the series connection direction into the last formation module and then flowing out from the power output terminal of the last formation module and returns to the negative terminal of the power module 100, thus forming a series loop. In the series loop, the currents passing through the formation modules are equal in magnitude. Optionally, the current flows in each formation module from the power input terminal of the each formation module, passes through the formation control circuit 300 and the battery cell 200 of the each formation module in turn, and flows out from the power output terminal of the each formation module. It should be noted that the series connection direction is from the positive terminal of the power module 100 through the formation modules in turn, and back to the negative terminal of the power module 100. The positive terminal of the power module 100 can be a power output terminal of the power module 100, and the negative terminal can be a power input terminal of the power module 100, which is not limited in this application.

In some embodiments, each formation module includes a formation control circuit 300 connected between the power module 100 and the battery cell 200. The formation control circuit 300 is configured to control the each formation module to work in the constant current charging mode or the constant voltage charging mode. Each formation module further includes a switch module 330. An output terminal of the switch module 330 is electrically connected to a first terminal of the battery cell 200, and another output terminal of the switch module 330 is electrically connected to a power output terminal B of the each formation module and a second terminal of the battery cell 200. The switch module 330 is configured to control a magnitude of the voltage across the battery cell 200 and/or a magnitude of the current flowing through the battery cell 200 to make the each formation module to work in the constant current charging mode or the constant voltage charging mode.

In some embodiments, the first terminal of the battery cell 200 is a positive terminal, and the second terminal of the battery cell 200 is a negative terminal.

Optionally, the switch module 330 may include a single-pole double-throw switch, a complementary metal-oxide-semiconductor transistor (CMOS) switch, a switch module composed of multiple switches, etc., as long as it can switch current flowing directions, which is not limited herein.

The switch module 330 includes at least a first state and a second state. When the switch module 330 is in the first state, a current at a power input terminal A of the each formation module flows through the switch module 330 and returns to the power output terminal B of the each formation module. When the switch module 330 is in the second state, the current at the power input terminal A of the each formation module flows through the switch module 330 and the battery cell 200 and returns to the power output terminal B of the each formation module. That is, in the first state, the current does not flow through the battery cell 200 of the each formation module, and in the second state, the current flows through the battery cell 200 of the each formation module. By switching between the first state and the second state through the switching module 330, the formation control circuit 300 realizes controlling of the voltage across the battery cell 200 and/or the current flowing through the battery cell 200. When the switch module 330 is continuously in the second state, the formation control circuit 300 controls the current flowing through the battery cell 200 of the each formation module. When the switch module 330 is switched repeatedly between the first state and the second state, the current provided by the power module 100 may intermittently flows through the battery cell 200 of the each formation module.

When the switch module 330 remains in the second state, the formation control circuit 300 controls the each formation module to be in the constant current charging mode; or when the switch module 330 is repeatedly switched between the first state and the second state, the formation control circuit 300 controls the each formation module to work in the constant voltage charging mode. In the constant current charging mode, when the voltage of the battery cell 200 is within the preset range, the switch module 330 starts to repeatedly switch between the first state and the second state to adjust the current flowing through the battery cell 200, thereby adjusting the charging voltage value of the battery cell 200, so that the battery cell 200 is in the constant voltage charging mode. In the constant voltage charging mode, the switch module 330 adjusts the current flowing through the battery cell 200 by controlling time periods that the switch module 330 are respectively in the first state and in the second state within a period, so as to adjust the voltages across the battery cell 200 to make the battery cell 200 in the constant voltage charging mode. It should be noted that a frequency of a periodic change of the switch module 330 can be set according to actual production requirements, which is not limited herein. For example, the state of the switch module 330 periodically changes at a certain frequency, and a time period, from an initial time when the switch module 330 starts and remains the first state to an end time when the switch module 330 ends the second state after switched from the first state to the second state and remaining the second state for some time, is defined as a change period.

In some embodiments, each formation control circuit 300 further includes a current limiting module 320. The current limiting module 320 has an input terminal electrically connected to the power input terminal A of the each formation module, and an output terminal electrically connected to an input terminal of the switch module 330 of the each formation module. The current limiting module 320 is configured to perform one or more of current limiting, voltage stabilizing, filtering, and energy storage on the formation control circuit 300.

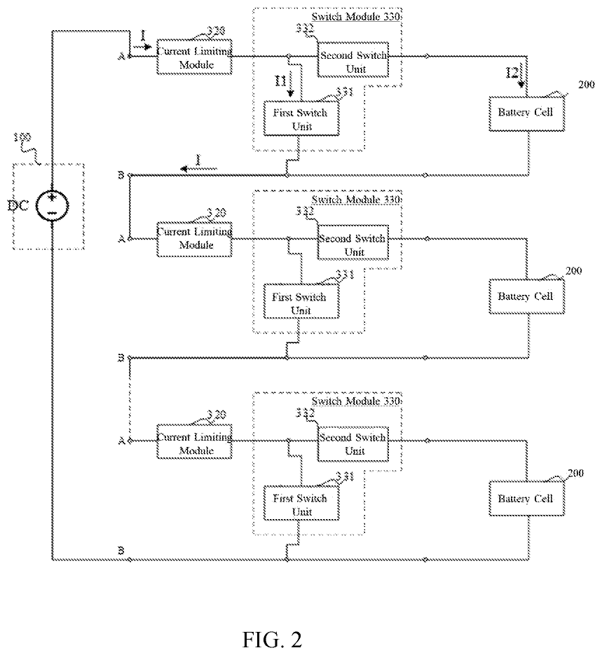

Referring to FIG. 2, each formation control circuit 300 includes the current limiting module 320 and the switch module 330. The each formation module includes the power input terminal A and the power output terminal B. One terminal of the current limiting module 320 is electrically connected to the power input terminal A, and another terminal of the current limiting module 320 is electrically connected to the switch module 300. One terminal of the battery cell 200 is electrically connected to the switch module 330, and another terminal of the battery cell 200 is electrically connected to the power output terminal B. The switch module 330 is further electrically connected to the power output terminal B. The switch module 330 includes at least the first state and the second state. When the switch module 330 is in the first state, the current flows from the power input terminal A through the current limiting module 320, the switch module 330, and the power output terminal B in turn. When the switch module is in the second state, the current flows from the power input terminal A through the current limiting module 320, the switch module 330, the battery cell 200, and the power output terminal B in turn. It should be noted that the switch module 330 may include other states for other purposes, which is not limited herein.

Taking the power module 100 as a constant current source as an example, during the battery formation process, firstly, the switch modules 330 in the formation control circuit 300 of each formation module continue to be in the second state. A constant current enters from the power input terminal A of the each formation module and flows out from the power output terminal B. Each battery cell 200 is in the constant current charging mode, wherein the charging current of each battery cell 200 is same, and the voltage value of each battery cell 200 continues to rise. In such case, the current limiting module 320 mainly provide a filtering function. As the voltage value of the battery cell 200 gradually rises, when the voltage across the battery cell 200 reaches the preset voltage value, the switch module 330 in the formation control circuit 300 of the each formation module is repeatedly switched between the first state and the second state, so that the each formation module is in the constant voltage charging mode. A time period that the switch module 330 is in the first state in one change period becomes longer, and a time period that the switch module 330 is in the second state becomes shorter. This makes the current flowing through the battery cell 200 gradually decrease, but in this process, the current passing through the power input terminal A and the power output terminal B of the each formation module remains unchanged. Therefore, in the series formation system provided by some embodiments of the present disclosure, the switching of the charging modes of the battery cell 200 in a single formation module will not affect the current flowing into the power input terminals of other formation modules, that is, it will not affect the charging modes of the battery cell 200 in other formation modules.

In some embodiments, referring to FIG. 2, the switch module 330 includes a first switch unit 331 and a second switch unit 332. An input terminal of the first switch unit 331 and an input terminal of the second switch unit 332 are electrically connected to an output terminal of the current limiting module 320, an output terminal of the first switch unit 331 is electrically connected to the power output terminal of the each formation module and the second terminal of the battery cell 200, and an output terminal of the second switch unit 332 is electrically connected to the first terminal of the battery cell 200. When the switch module 330 is in the first state, the first switch unit 331 is turned on, the second switch unit 332 is turned off, and the current flows from the power input terminal A through the current limiting module 320, the first switch unit 331, and the power output terminal B. When the switch module 330 is in the second state, the second switch unit 332 is turned on, the first switch unit 331 is turned off, and the current flows from the power input terminal A through the current limiting module 320, the second switch unit 332, the battery cell 200, and the power output terminal B.

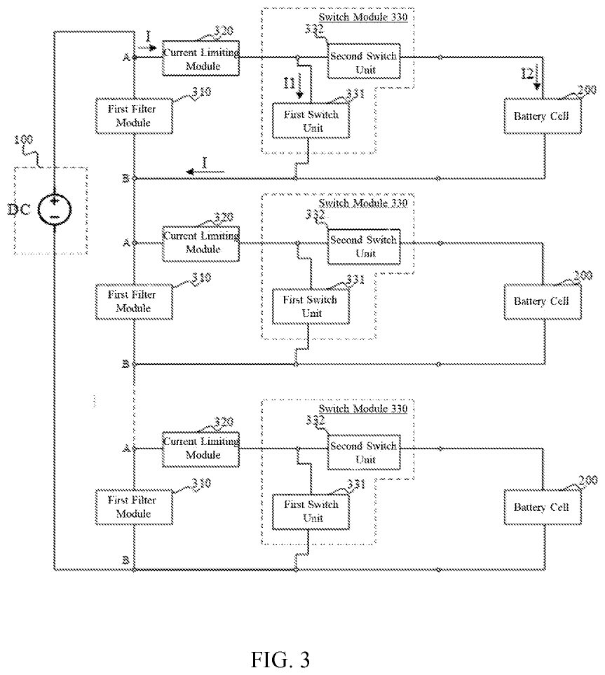

In some embodiments, referring to FIG. 3, the formation control circuit 300 further includes a first filter module 310. A terminal of the first filter module 310 is electrically connected to the power input terminal A of the each formation module, another terminal of the first filter module is electrically connected to the power output terminal B of the each formation module, and a current flowing through the power input terminal A and a current flowing through the power output terminal B have a same magnitude. The first filter module 310 mainly plays a filter function, especially in the constant voltage charging mode.

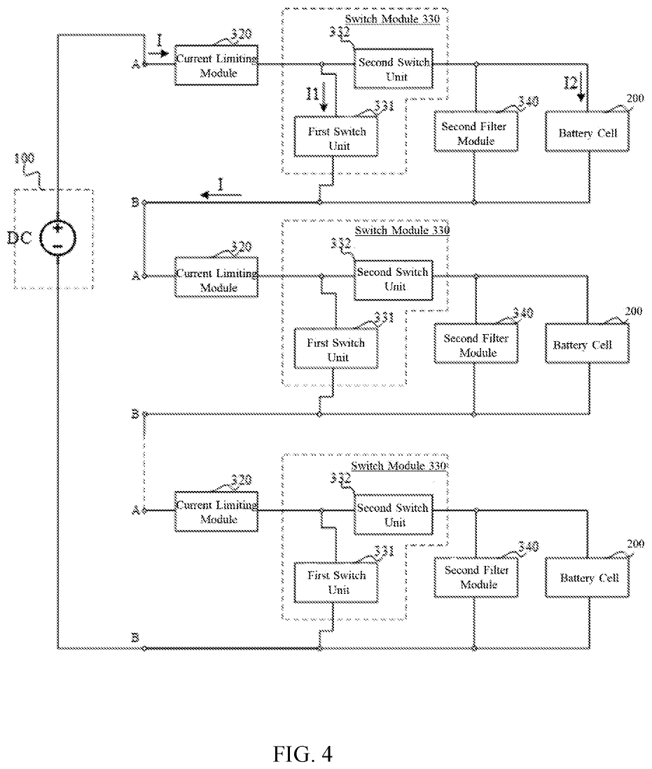

In some embodiments, referring to FIG. 4, the formation control circuit 300 further includes a second filter module 340 electrically connected between the switch module 330 and the battery cell 200. The second filter module 340 is connected to the battery cell 200 in parallel. A terminal of the second filter module 340 is electrically connected to the switch module 330 and the battery cell 200, and another terminal of the second filter module 340 is electrically connected to the power output terminal B. The second filter module 340 mainly plays a filtering function, especially in the constant voltage charging mode.

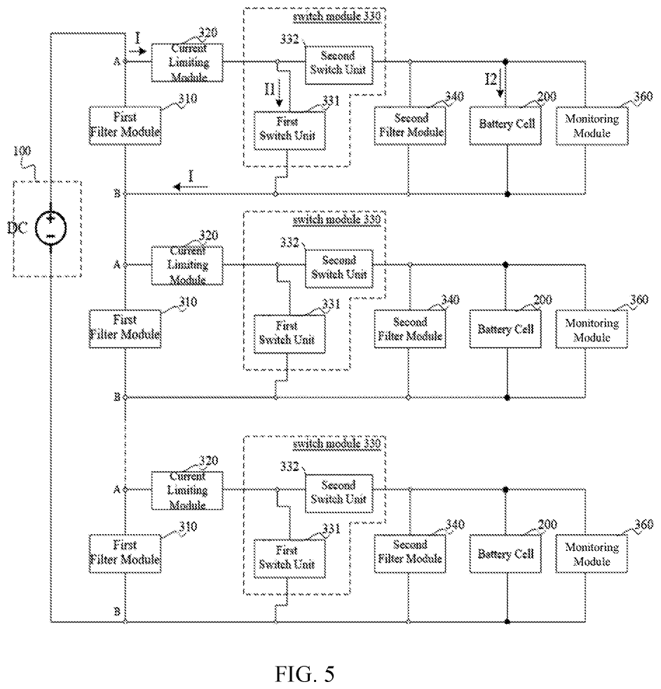

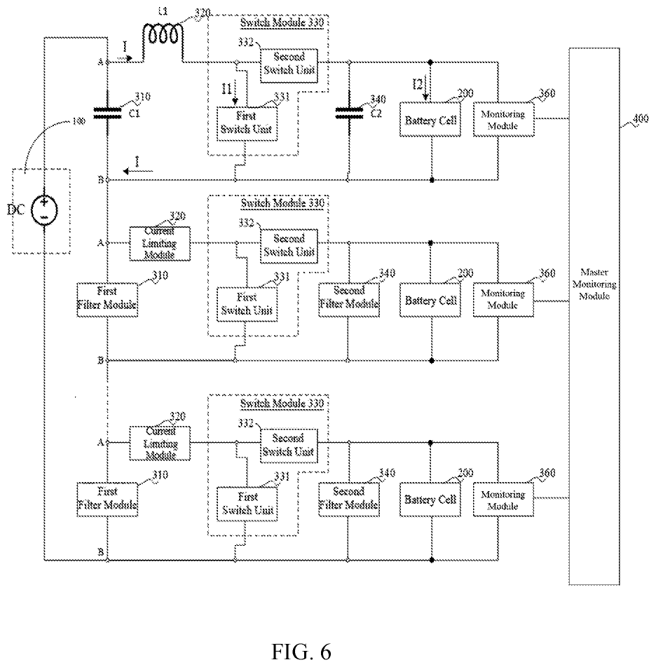

In some embodiments, referring to series formation systems shown in FIG. 5 or FIG. 6, the formation control circuit 300 includes: the first filter module 310, the current limiting module 320, the switch module 330, and the second filter module 340. Each formation module includes the power input terminal A and the power output terminal B. A terminal of the first filter module 310 is electrically connected to the power input terminal A, and another terminal of the first filter module 310 is electrically connected to the power output terminal B. A terminal of the current limiting module 320 is electrically connected to the power input terminal A, and another terminal of the current limiting module 320 is electrically connected to the switch module 300. A terminal of the second filter module 340 is electrically connected to the switch module 330, and another terminal of the second filter module 340 is electrically connected to the power output terminal B. A terminal of the battery cell 200 is electrically connected to the switch module 330, and another terminal of the battery cell 200 is electrically connected to the power output terminal B. The switch module 330 is also electrically connected to the power output terminal B. In some embodiments, the first filter module 310 includes a capacitor Cl, the current limiting module 320 includes an inductor L1, and each of the first switch unit 331 and the second switch unit 332 includes a metal oxide semiconductor (MOS) tube. The second filter module 340 includes a capacitor C2. In the constant voltage charging mode, when the first switch unit 331 is turned off and the second switch unit 332 is turned on, the capacitor C2 in the second filter module 340 performs filtering on the circuit, and the voltage across the battery cell 200 is relatively stable. When the first switch unit 331 is turned off and the second switch unit 332 is turned on, the capacitor C2 in the second filter module 340 can provide some current to the battery cell 200, thereby ensuring that the battery cell 200 continues to be charged. Similarly, in the constant voltage charging mode, when the first switch unit 331 is turned off and the second switch unit 332 is turned on, or when the first switch unit 331 is turned on and the second switch unit 332 is turned off, the capacitor C1 in the first filter module 310 also performs filtering on the circuit, making the voltage across the formation module relatively stable, thereby reducing an impact on other formation modules when a single formation module is switched between the constant current charging mode and the constant voltage charging mode.

In some embodiments, the formation module further includes a monitoring module 360. The monitoring module 360 is electrically connected to the battery cell 200, and the monitoring module 360 is configured to detect a value of the voltage across the battery cell 200. The monitoring module 360 is further electrically connected to the formation control circuit 300. Under a control of the monitoring module 360, the formation control circuit 300 controls a magnitude of the voltage applied by the power module 100 to the battery cell 200 and/or controls a magnitude of the current provided by the power module 100 to flow through the battery cell 200 based on the value of the voltage detected by the monitoring module 360, so that the battery cell 200 is switched between the constant current charging mode and the constant voltage charging mode. In some embodiments, the monitoring module 360 includes a single-chip microcomputer. The monitoring module 360 is respectively connected to the battery cell 200 and the switch module 330. The monitoring module 360 controls the switch module 330 to switch between the first state and the second state according to the detected value of the voltage of the battery cell 200. For example, the monitoring module 360 may send modulation and demodulation signal to the first switch unit 331 and the second switch unit 332 to control the first switch unit 331 and the second switch unit 332 to turn on or off, that is, to control duty cycles of the first switch unit 331 and the second switch unit 332.

In some embodiments, the series formation system further includes a master monitor system 400. The master monitor system 400 communicates with the monitoring module 360 in each formation module. The master monitor system 400 is configured to receive parameters fed back from the monitoring module 360, process the parameters, and control the switch module 330 through the monitoring module 360 according to a processing result. The parameters fed back by the monitoring module 360 include the value of the voltage of the battery cell 200, the voltage applied to the battery cell 200, a temperature of the battery cell 200, the current flowing through the battery cell 200, the state of the switch module 330, etc., which are not limited herein. In addition, the master monitor system 400 may be provided to directly monitor and control the parameters of each formation module without the monitoring module 360. Optionally, the master monitor system 400 may be a host computer, a computer, etc., which is not limited in embodiments of the application.

In some embodiments, the formation control circuit further includes an anti-reverse connection module (not shown in the figures), a terminal of the anti-reverse connection module is electrically connected to the battery cell 200, and another terminal is electrically connected to the power output terminal. The anti-reverse connection module is configured to prevent a short circuit caused by a reverse connection of the battery cell 200.

In some embodiments, the power module 100 includes, but is not limited to, a constant current source, which is not limited herein.

In some embodiments, a series formation method applied to a series formation system (e.g., the series formation systems as described in elsewhere in the present disclosure) is provided. The method includes: transmitting electrical energy from the power module to each of the formation modules for battery formation of the battery cell; the formation control circuit controlling the each of the formation modules to continuously work in a constant current charging mode for a first period of time to perform constant current charging of the battery cell; in response to determining that the voltage across the battery cell reaches a preset voltage value, the formation control circuit switching the each of the formation modules to a constant voltage charging mode to perform constant voltage charging of the battery cell; and in response to determining that the constant voltage charging is completed, disconnecting the battery cell with the series formation system.

Furthermore, the formation module is configured to use the switch module 330 to realize various charging modes, so as to control the voltage across the battery cell 200 and/or the current flowing through the battery cell 200. Each formation module includes the switch module 300 including the first state and the second state. The each of the formation modules is controlled to work in one of the constant current charging mode and the constant voltage charging mode by adjusting the state of the switch module 330 and/or duty cycles respectively in the first state and in the second state. When the switch module 330 is in the first state, a current at the power input terminal A of the each formation module flows through the switch module 330 to the power output terminal B of the each formation module. When the switch module 330 is in the second state, the current at the power input terminal A of the each formation module flows through the switch module 330 and the battery cell 200 to the power output terminal B of the each formation module.

The formation control circuit 300 controlling the each of the formation modules to continuously work in the constant current charging mode for the first period of time comprises: controlling the switch module 330 to remain in the second state for the first period of time, so that the each of the formation modules works in the constant current charging mode. The formation control circuit 300 switching the each of the formation modules to the constant voltage charging mode comprises: controlling the switch module 330 to repeatedly switch between the first state and the second state, so that the each of the formation modules works in the constant voltage charging mode.

In some embodiments, the series formation system adapted to the series formation method includes the switch module 330. The switch module 330 further includes: the first switch unit 331 and the second switch unit 332. The first switch unit 331 is controlled to turn on and the second switch unit 332 is controlled to turn off, so that the switch module 330 is in the first state. In such case, the current flows from the power input terminal A through the first switch unit 331 to the power output terminal B. The second switch unit 332 is controlled to turn on and the first switch unit 331 is controlled to turn off, so that the switch module 330 is in the second state. In such case, the current flows from the power input terminal A, through the second switch unit 332, the battery cell 200, to the power output terminal B. The voltage applied to the battery cell 200 and/or the current flowing through the battery cell 200 is controlled based on adjustment of the states of the switch module 330.

The disconnecting of the battery cell 200 with the series formation system in response to the constant voltage charging being completed includes: controlling the switch module 330 to remain in the first state, so that the current at the power input terminal A of the each formation module returns to the power output terminal B of the each formation module through the switch module 330.

In some embodiments, the series formation system adapted to the series formation method further includes a boost circuit composed of the current limiting module 320, the first switch unit 331, and the second switch unit 332. The current flowing into the power input terminal A is denoted as I, the current flowing through the first switch unit 331 is denoted as I1, and the current flowing through the battery cell 200 is denoted as I2.

During the battery formation process, if the second switch unit 332 in each formation module continues to be turned on and the first switch unit 331 in the each formation module is turned off, I2=I, I1=0, and I1+I2=I. In such case, the battery cell 200 is in the constant current charging mode, and the battery cell 200 continues to be charged at a substantially constant current. When the voltage across the battery cell 200 reaches the preset voltage value, the first switch unit 331 and the second switch unit 332 in the each formation module are alternately turned on at a certain frequency, which enables the battery cell 200 to be work in the constant voltage mode. That is, within one cycle, the switch module 330 is switched between the first state and the second state, so that the battery cell 200 is in the constant voltage charging mode. In such case, the current limiting module 320, the first switch unit 331, and the second switch unit 332 form a boost circuit. By controlling the duty cycles of the first switch unit 331 and the second switch unit 332, the current flowing through the battery cell 200 may be controlled, that is, the voltage across the battery cell 200 may be controlled, thereby achieving constant voltage charging.

In some embodiments, the current limiting module 320 includes an inductor L1. In the constant voltage charging mode, the first switch unit 331 and the second switch unit 332 are turned on alternately. When the first switch unit 331 is turned on and the second switch unit 332 is turned off, the current passes through the current limiting module 320 and the inductor L1 in the current limiting module 320 gradually stores energy. When the first switch unit 331 is turned off and the second switch unit 332 is turned on, the power module and the current limiting module 320 simultaneously supply energy to the battery cell 200, and the inductor L1 is discharged. In order to prevent a sudden change in current, the inductor L1 will generate a voltage. That is, an output voltage of the current limiting module 320 is greater than an input voltage of the current limiting module 320, thereby increasing the voltage across the battery cell 200.

During the constant voltage charging, the voltage applied to two terminals of the battery cell 200 is substantially constant. As the constant voltage charging of the battery cell 200 progresses, the voltage across the battery cell 200 continues to increase, and the charging current of the battery cell 200 will gradually decrease. By gradually increasing a time of the first switching unit 331 in a turned-on state within one cycle (that is, a duty cycle of the first switching unit 331 gradually increases), and at the same time, gradually reducing a time of the second switching unit 332 in a turned-on state within one cycle (that is, a duty cycle of the second switching unit 332 gradually decreases), an average value of the current flowing through the battery cell 200 within one cycle may be gradually decreased, thereby achieving the constant voltage charging of the battery cell 200.

In each formation module, if the second switch unit 332 continues to be turned on and the first switch unit 331 continues to be turned off, the battery cell 200 is in the constant current charging mode. As the voltage across the battery cell 200 gradually increases, if the voltage across the battery cell 200 is within the preset range (i.e., reaching the present voltage value), the first switch unit 331 and the second switch unit 332 are alternately turned on, so that the constant current charging mode is switched to the constant voltage charging mode. In such case, the duty cycle of the first switch unit 331 is getting larger and larger, and accordingly I1 is also getting larger and larger; while the duty cycle of the second switch unit switch 332 is getting smaller and smaller, and I2 is also getting smaller and smaller accordingly. During this process, it is maintained that I1+I2=I, so that in the series charging system, I2 may be gradually reduced. In some embodiments, I1 may be an average current flowing through the first switching unit 331 within one cycle, and I2 may be an average current flowing through the second switching unit 332 within one cycle. This is because under the circumstances that the first switch unit 331 is turned off, in response to the duty cycle of the first switch unit 331 being greater than zero for the first time, the first switch unit 331 is turned on. When the second switch unit 332 is turned off, the current flowing through the first switch unit 331 is i1. As the duty cycle of the first switch unit 331 increases, the current of the first switch unit 331 will gradually increase from i1. In such case, if the first switch unit 331 is turned off and the second switch unit 332 is turned on, the current flowing through the second switch unit 332 is I4. As the duty cycle of the second switch unit 332 decreases, the current flowing through the second switch unit 332 will gradually decrease from I4. That is, in such case, as long as the duty cycle of the first switch unit 331 in the boost circuit gradually increases and the duty cycle of the second switch unit 332 gradually decreases, the voltage across the battery cell 200 may be controlled to achieve the constant voltage charging. In some embodiments, i1 may be an average current flowing through the first switching unit 331 within one cycle immediately after the duty cycle of the first switch unit 331 is greater than zero for the first time, and i2 may be an average current flowing through the second switching unit 332 within the cycle immediately after the duty cycle of the first switch unit 331 is greater than zero for the first time.

In some embodiments, in addition to the switch module 330, the series formation system adapted to the series formation method further includes the first filter module 310, the current limiting module 320, and the second filter module 340. The first filter module 310, the current limiting module 320, and the second filter module 340 play the roles of filtering and voltage stabilization. The current flowing into the power input terminal A is denoted as I, the current flowing through the first switch unit 331 is denoted as I1, and the current flowing through the battery cell 200 is denoted as I2.

In the constant current charging mode, since the current is relatively stable, the current limiting module 320 only functions as current filtering and does not have a current limiting function.

In the constant voltage charging mode, the first switch unit 331 and the second switch unit 332 are turned on alternately. When the first switch unit 331 is turned on and the second switch unit 332 is turned off, the current passes through the current limiting module 320, and the inductor L1 in the current limiting module 320 gradually stores energy. When the first switch unit 331 is turned off and the second switch unit 332 is turned on, the power module 100 and the current limiting module 320 simultaneously supply energy to the battery cell 200, and the inductor L1 is discharged. In order to prevent a sudden change in current, the inductor L1 will generate a voltage, that is, an output voltage of the current limiting module is greater than the input voltage of the current limiting module 320, thereby increasing the voltage across the battery cell 200.

During the constant voltage charging, the voltage applied to two terminals of the battery cell 200 is substantially constant. As the constant voltage charging of the battery cell 200 progresses, the voltage across the battery cell 200 continues to increase, and the charging current of the battery cell 200 will gradually decrease. By gradually increasing a time of the first switching unit 331 in a turned-on state within one cycle (that is, a duty cycle of the first switching unit 331 gradually increases), and at the same time, gradually reducing a time of the second switching unit 332 in a turned-on state within one cycle (that is, a duty cycle of the second switching unit 332 gradually decreases), an average value of the current flowing through the battery cell 200 within one cycle may be gradually decreased, thereby achieving the constant voltage charging of the battery cell 200.

In each formation module, if the second switch unit 332 continues to be turned on and the first switch unit 331 continues to be turned off, the battery cell 200 is in the constant current charging mode. As the voltage across the battery cell 200 gradually increases, if the voltage across the battery cell 200 is within the preset range (i.e., reaching the preset voltage value), the first switch unit 331 and the second switch unit 332 are alternately turned on, so that the constant current charging mode is switched to the constant voltage charging mode. In such case, the duty cycle of the first switch unit 331 is getting larger and larger, and accordingly I1 is also getting larger and larger; while the duty cycle of the second switch unit switch 332 is getting smaller and smaller, and I2 is also getting smaller and smaller accordingly. During this process, it is maintained that I1+I2=I, so that in the series charging system, I2 may be gradually reduced. This is because in the constant voltage charging module, the first switch unit 331 is turned off, and a voltage across the capacitor C2 is equal to the voltage across the battery cell 200. In response to the duty cycle of the first switch unit 331 being greater than zero for the first time, the first switch unit 331 is turned on. When the second switch unit 332 is turned off, the current flowing through the first switch unit 331 is i1. As the duty cycle of the first switch unit 331 increases, the current of the first switch unit 331 will gradually increase from i1. At this time, the current flowing through the power input terminal A can no longer charge the capacitor C2 and the battery cell 200. A small part of energy of the capacitor C2 may charge the battery cell 200 to maintain the constant voltage charging of the battery cell 200. In such case, if the first switch unit 331 is turned off and the second switch unit 332 is turned on, the current flowing through the second switch unit 332 is i2. As the duty cycle of the second switch unit 332 decreases, the current flowing through the second switch unit 332 will gradually decrease from i2. That is, in such case, as long as the duty cycle of the first switch unit 331 in the boost circuit gradually increases and the duty cycle of the second switch unit 332 gradually decreases, the voltage across the capacitor C2 (i.e., the voltage across the battery cell 200) may be controlled to achieve the constant voltage charging. In some embodiments, it may be an average current flowing through the first switching unit 331 within one cycle immediately after the duty cycle of the first switch unit 331 is greater than zero for the first time, and i2 may be an average current flowing through the second switching unit 332 within the cycle immediately after the duty cycle of the first switch unit 331 is greater than zero for the first time. Within the one cycle immediately after the duty cycle of the first switch unit 331 is greater than zero for the first time, I1=i1 and I2=i2. In addition, the capacitor C1 may eliminate an instantaneous impact of line inductance and switch dead zones of other integrated modules on the input voltage and avoids instability of the charging current caused by input voltage jumps. The capacitor C2 further plays a role in eliminating the effect on fluctuation coming from the output line inductance.

In some embodiments, when the battery cell 200 of a formation module is charged in the constant voltage charging mode for a period of time and after the formation is completed, the switch module 330 continues to maintain the first state, the battery cell 200 is disconnected from the charging circuit, and the current flows from the power input terminal of the formation module through the current limiting module 320, the switch module 330, and the power output terminal of the formation module in turn, and then flows into the power input terminal A of a next formation module in the series connection direction. In detail, the first switch unit 331 is continuously turned on, the second switch unit 332 is continuously turned off, and the current flows from the power input terminal through the current limiting module 320, the first switch unit 331, and the power output terminal in turn, and then flows into the next formation module in the series connection direction, while the current is still equal to I. In this case, the battery cell 200 that has been completed the formation can be taken out of the series formation system and enter a next process.

In some embodiments, the value of the voltage of the battery cell 200 may be detected by the monitoring module 360. Based on the value of the voltage obtained by the monitoring module 360, the power module 100 controls the voltage applied to the battery cell 200 and/or the current flowing through the battery cell 200, so that the battery cell 200 is switched between the constant current charging mode and the constant voltage charging mode. For example, the monitoring module 360 may send modulation and demodulation signals to the first switch unit 331 and the second switch unit 332 to control the first switch unit 331 and the second switch unit 332 to turn on or off, that is, to control duty cycles of the first switch unit 331 and the second switch unit 332.

The series formation methods and the series formation systems provided by the some embodiments of present disclosure realize battery formation through switching between the constant current charging and the constant voltage charging of a single formation module, without affecting the current flowing into the power input terminals of other formation modules. This enables some battery cells 200 are charged in the constant current mode and some other battery cells 200 are charged in the constant voltage mode simultaneously, without cutting off the circuit. The series formation systems and method have advantages of high switching speed, no fluctuation in the current flowing into the power input terminals of the formation modules, and minor damage to the battery cell 200.

In addition, when the battery cell reaches the preset voltage value, if the battery cell continues to be charged in the constant current charging mode, the battery cell may easily be excessively polarized, thereby affecting the product quality of the battery cell. Besides, since the times for the battery cells to reach the preset voltage value are inconsistent, waiting all of the battery cells to reach the preset voltage value before performing the constant voltage charging further cause durations of excessive constant current charging for each battery cell to be inconsistent, which not only affects the product quality of the battery cell, but also makes the quality of the battery cells formed in a same batch in the series formation system inconsistent, which is not conducive to consistency of products. A seamless connection between the constant current charging mode and the constant voltage charging mode makes the solid electrolyte interface film generated during the battery formation of the battery cell dense and makes the electrochemical property of the battery cell more stable. Compared with constant voltage charging at an interval after the constant current charging, the series formation systems and methods herein not only ensures the formation quality of each battery cell, but also ensures the consistency of multiple battery cells, so that the formed battery cells are all high-quality products with extremely similar electrochemical properties, which makes it more convenient to form a battery module with multiple battery cells for use.

In some embodiments, the terms “about,” “approximate,” or “substantially” may indicate ±1%, ±5%, ±10%, etc., variation of the value it describes, unless otherwise stated.

The various technical features of the above embodiments can be combined arbitrarily. To make the description concise, not all possible combinations of the various technical features in the above embodiments are described. However, as long as there is no contradiction in the combination of these technical features, it should be considered to be within the range described in the application.

The above embodiments only describe several implementations of the application, and the descriptions are more specific and detailed, but cannot therefore be considered as limitations on the scope of invention patents. It should be noted that for those of ordinary skill in the art, under the premise of not departing from the concept of the application, several modifications and improvements can also be made, which all belong to the scope of protection of the application. Therefore, the scope of protection of the application shall be subject to the appended claims.

What is claimed is:

1. A series formation system, comprising:
a power module; and
at least two formation modules connected in series with the power module, wherein the at least two formation modules are connected in series,
wherein the power module is configured to supply power to the at least two formation modules;
wherein each of the formation modules comprises a battery cell and a formation control circuit connected between the power module and the battery cell, the formation control circuit being configured to control the each of the formation modules to work in one of: a constant current charging mode in which a current flowing through the battery cell is substantially constant, and a constant voltage charging mode in which a voltage across the battery cell is substantially constant; and
wherein the each of the formation modules is controlled to: work in the constant current charging mode for a first period of time to perform constant current charging of the battery cell; and in response to determining that the voltage across the battery cell reaches a preset voltage value, work in the constant voltage charging mode to perform constant voltage charging of the battery cell.

2. The series formation system of claim 1, wherein the formation control circuit comprises:
a switch module having a first output terminal electrically connected to a first terminal of the battery cell and a second output terminal electrically connected to a power output terminal of the each of the formation modules and a second terminal of the battery cell, and wherein the switch module is configured to control at least one of a magnitude of the voltage across the battery cell or a magnitude of the current flowing through the battery cell, so that the each of the formation modules works in one of the constant current charging mode and the constant voltage charging mode.

3. The series formation system of claim 2, wherein:
the switch module has a first state and a second state,
wherein when the switch module is in the first state, a current at a power input terminal of the each of the formation modules flows through the switch module to the power output terminal of the each of the formation modules; and when the switch module is in the second state, the current at the power input terminal of the each of the formation modules flows through the switch module and the battery cell to the power output terminal of the each of the formation modules.

4. The series formation system of claim 3, wherein:
when the switch module remains in the second state, the formation control circuit controls the each of the formation modules to work in the constant current charging mode; and
when the switch module is repeatedly switched between the first state and the second state, the formation control circuit controls the each of the formation modules to work in the constant voltage charging mode.

5. The series formation system of claim 2, wherein the formation control circuit further comprises:
a current limiting module having an input terminal electrically connected to a power input terminal of the each of the formation modules and an output terminal electrically connected to an input terminal of the switch module,
wherein the current limiting module is configured to perform one or more of current limiting, voltage stabilizing, filtering, and energy storage for the formation control circuit.

6. The series formation system of claim 5, wherein the switch module comprises a first switch unit and a second switch unit, and
an input terminal of the first switch unit and an input terminal of the second switch unit are electrically connected to the output terminal of the current limiting module,
an output terminal of the first switch unit is electrically connected to the power output terminal of the each of the formation modules and the second terminal of the battery cell, and
an output terminal of the second switch unit is electrically connected to the first terminal of the battery cell.

7. The series formation system of claim 2, wherein the formation control circuit further comprises:
a first filter module having a terminal electrically connected to a power input terminal of the each of the formation modules and another terminal electrically connected to the power output terminal of the each of the formation modules,
wherein a current flowing through the power input terminal of the each of the formation modules and a current flowing through the power output terminal of the each of the formation modules have a same magnitude.

8. The series formation system of claim 2, wherein the formation control circuit further comprises:
a second filter module electrically connected between the switch module and the battery cell, the second filter module being connected in parallel with the battery cell.

9. The series formation system of claim 1, wherein in a series connection direction of the at least two formation modules, a power input terminal of each formation module of the formation modules except the first one of the formation modules is electrically connected to a power output terminal of one of the formation modules immediately preceding the each formation module.

10. The series formation system of claim 9, wherein in the series connection direction, a power input terminal of the first one of the formation modules is electrically connected to a positive terminal of the power module, and a power output terminal of the last one of the formation modules is electrically connected to a negative terminal of the power module.

11. The series formation system of claim 1, wherein when a value of the voltage across the battery cell is within a preset range, it is determined that the voltage across the battery cell reaches the preset voltage value.

12. The series formation system of claim 1, wherein the each of the formation modules further comprises:
a monitoring module electrically connected to the battery cell and configured to detect a value of the voltage across the battery cell.

13. The series formation system of claim 12, wherein the monitoring module is further electrically connected to the formation control circuit, under a control of the monitoring module, the formation control circuit uses the value of the voltage detected by the monitoring module is configured to control at least one of a magnitude of the voltage across the battery cell or a magnitude of the current flowing through the battery cell based on the value of the voltage detected by the monitoring module.

14. The series formation system of claim 1, wherein the power module comprises a constant current source.

15. A series formation method applied to a series formation system, wherein:
the series formation system comprises a power module and at least two formation modules connected in series with the power module, the at least two formation modules are connected in series, and each of the formation modules comprise a battery cell and a formation control circuit;
the method comprises:
transmitting electrical energy from the power module to each of the formation modules for battery formation of the battery cell;
the formation control circuit controlling the each of the formation modules to continuously work in a constant current charging mode for a first period of time to perform constant current charging of the battery cell;
in response to determining that the voltage across the battery cell reaches a preset voltage value, the formation control circuit switching the each of the formation modules to a constant voltage charging mode to perform constant voltage charging of the battery cell; and
in response to determining that the constant voltage charging is completed, disconnecting the battery cell with the series formation system.

16. The series formation method of claim 15, wherein:
the formation control circuit comprises a switch module having a first state and a second state,
wherein the each of the formation modules is controlled to work in one of the constant current charging mode and the constant voltage charging mode by switching between the first state and the second state of the switch module and/or changing duty cycles respectively in the first state and in the second state; and
when the switch module is in the first state, a current at a power input terminal of the each of the formation modules flows through the switch module to a power output terminal of the each of the formation modules; and when the switch module is in the second state, the current at the power input terminal of the each of the formation modules flows through the switch module and the battery cell to the power output terminal of the each of the formation modules.

17. The series formation method of claim 16, wherein:
the formation control circuit controlling the each of the formation modules to continuously work in the constant current charging mode for the first period of time comprises: controlling the switch module to remain in the second state for the first period of time, so that the each of the formation modules works in the constant current charging mode; and
the formation control circuit switching the each of the formation modules to the constant voltage charging mode comprises: the formation control circuit controlling the switch module to repeatedly switch between the first state and the second state, so that the each of the formation modules works in the constant voltage charging mode.

18. The series formation method of claim 16, wherein the disconnecting of the battery cell with the series formation system in response to determining that the constant voltage charging is completed comprises:
controlling the switch module to remain in the first state, so that the current at the power input terminal of the each of the formation modules flows through the switch module to the power output terminal of the each of the formation modules.

19. The series formation method of claim 16, wherein the switch module comprises a first switch unit and a second switch unit for controlling switching,
when the first switch unit is turned on and the second switch unit is turned off, the switch module is in the first state, and
when the second switch unit is turned on and the first switch unit is turned off, the switch module is in the second state.

20. The series formation method of claim 15, wherein the formation control circuit comprises a first switch unit and a second switch unit for controlling switching between the constant current charging mode and the constant voltage charging mode;
the formation control circuit controlling the each of the formation modules to work in the constant current charging mode for the first period of time comprises: controlling the first switch unit to turn off for the first period of time and the second switch unit to turn on for the first period of time, so that the each of the formation modules works in the constant current charging mode; and
the formation control circuit switching the each of the formation modules to the constant voltage charging mode comprises: alternately turning on the first switch unit and the second switch unit, and controlling a duty cycle of the first switch unit when turned on and a duty cycle of the second switch unit when turned on, so that the each of the formation modules works in the constant voltage charging mode.
